(19) United States
(12) Patent Application Publication
(10) Pub. No.: US 2026/0228029 A1
(43) Pub. Date: Aug. 6, 2026

(54) VIRTUAL MACHINE OPTIMAL ARRANGEMENT RECOMMENDATION APPARATUS AND SERVER OPERATION SYSTEM COMPRISING SAME

(71) Applicant: OKESTRO CO., LTD., Seoul (KR)

(72) Inventors: Chang Hoon LEE, Seoul (KR); Moon Gi HONG, Seoul (KR); Young Gwang KIM, Seoul (KR); Min Jun KIM, Seoul (KR)

(73) Assignee: OKESTRO CO., LTD., Seoul (KR)

(21) Appl. No.: 19/142,435

(22) PCT Filed: Dec. 30, 2022
(86) PCT No.: PCT/KR2022/021700

§ 371 Date: Jun. 23, 2025

(30) Foreign Application Priority Data
Dec. 27, 2022 (KR) 10-2022-0185627
Dec. 27, 2022 (KR) 10-2022-0185688

(51) Int. Cl. G06F 9/455

(52) U.S. Cl. CPC G06F 9/45558; G06F 2009/4557; G06F 2009/45595

(57) ABSTRACT

A virtual machine optimal arrangement recommendation apparatus according to an embodiment of the present invention may be a virtual machine optimal arrangement recommendation apparatus for optimal arrangement of a virtual machine operated on a physical server and may include a collection module configured to collect operation information, which is information generated when a manager operates the physical server; a preference evaluation module configured to calculate a preference evaluation value related to management preference of the manager by using a predetermined preference calculation method based on the operation information; and a recommendation module configured to calculate recommendation information for recommending virtual machine arrangement on the physical server to the manager by reflecting the preference evaluation value.

### TECHNICAL FIELD

The present invention relates to a virtual machine optimal arrangement recommendation apparatus for arranging and managing virtual machines on a physical server, and a server operation system comprising same.

### BACKGROUND ART

As the technological capabilities of an Internet network increase and spatial constraints on computer work such as telecommuting disappear, a cloud environment has been growing rapidly recently. For a business operator providing a cloud service, it is very important to know how to manage virtual machines on a physical machine in order to provide cloud services without interruption.

Previously, a recommendation plan is provided to operate a minimum number of servers by migrating virtual machines from a server with low usage to a server with high usage in stages using a first-fit decreasing algorithm. However, when a server operation is minimized, other operating servers become overloaded, which causes instability in terms of server stability.

### DISCLOSURE

### Technical Problem

The present invention is intended to solve the above-described problem, and is directed to providing a virtual machine optimal arrangement recommendation apparatus that objectively evaluates and determines the arrangement of a virtual machine and recommends a virtual machine optimal arrangement based on a result thereof, and a server operation system including the same.

### Technical Solution

A virtual machine optimal arrangement recommendation apparatus according to an embodiment of the present invention is a virtual machine optimal arrangement recommendation apparatus for optimal arrangement of a virtual machine operated on a physical server, the virtual machine optimal arrangement recommendation apparatus including: a collection module configured to collect operation information, which is information generated when a manager operates the physical server; a preference evaluation module configured to calculate a preference evaluation value related to management preference of the manager by using a predetermined preference calculation method based on the operation information; and a recommendation module configured to calculate recommendation information for recommending virtual machine arrangement on the physical server to the manager by reflecting the preference evaluation value.

Further, the virtual machine optimal arrangement recommendation apparatus may further include an arrangement calculation module configured to calculate an optimal arrangement which is a virtual machine arrangement on the physical server that satisfies a predetermined arrangement condition, wherein the arrangement calculation module may receive an arrangement evaluation value obtained by the arrangement evaluation module evaluating the optimal arrangement using a predetermined evaluation method, and the recommendation module may classify the optimal arrangements in order of similarity of the arrangement evaluation value to the preference evaluation value according to a predetermined recommendation method, to select a virtual machine arrangement to be recommended.

Further, preference evaluation value and the arrangement evaluation value may be calculated in consideration of stability and efficiency aspects.

Further, the predetermined preference calculation method may be a method of classifying the operation pattern of the virtual machine management system of the manager based on the operation information to calculate the preference evaluation value.

Further, the predetermined recommendation method may be a method of comparing the arrangement evaluation value with the preference evaluation value to recommend virtual machine arrangement in order of similarity, and weighting the stability to recommend the virtual machine arrangement when the similarity of the stability and the similarity of the efficiency are the same.

Further, the virtual machine optimal arrangement recommendation apparatus may further include an interface module configured to produce an interface for displaying the recommendation information generated by the recommendation module to the manager, wherein the interface module may produce the interface for displaying both optimal arrangement information and the recommendation information.

Further, the interface module may change the preference evaluation value between a minimum value and a maximum value and produce an interface for recommending the virtual machine arrangement on the physical server by reflecting the changed preference evaluation value.

Further, the collection module may collect personal information of the manager when a predetermined collection amount of operation information is not collected, and the predetermined preference calculation method may be a method of calculating the preference evaluation value in consideration of both the personal information and the operation information.

Further, the virtual machine optimal arrangement recommendation apparatus may further include a proficiency determination module configured to determine proficiency of a manager in operating the virtual machine management system based on the operation information, wherein the predetermined preference calculation method may be a method of calculating the preference evaluation value by changing a weight to which the personal information and the operation information are applied based on the operation proficiency.

A method of recommending optimal arrangement of a virtual machine according to an embodiment of the present invention is a method of recommending optimal arrangement of a virtual machine implemented by a virtual machine management system to operate a virtual machine operated on a physical server, the virtual machine management method including: collecting, by a collection module, operation information, which is information generated when a manager controls the virtual machine management system; calculating, by a preference evaluation module, a preference evaluation value related to preference of the manager by using a predetermined preference calculation method based on the operation information; and selecting, by a recommendation module, virtual machine arrangement on the physical server to the manager by reflecting the preference evaluation value.

A virtual machine arrangement evaluation apparatus according to an embodiment of the present invention may be a virtual machine arrangement evaluation apparatus for calculating an arrangement evaluation value, which indicates an evaluation for an arrangement of a virtual machine operated on a physical server, and may include a reception module that collects operation information, which is information generated when the virtual machine is operated, a first calculation module that calculates an efficiency evaluation value, which is a value for the efficiency of the virtual machine arrangement, based on the operation information, a second calculation module that calculates a stability evaluation value, which is a value for the stability of the virtual machine arrangement, based on the operation information, and an arrangement evaluation module that calculates the arrangement evaluation value by utilizing the efficiency evaluation value and the stability evaluation value.

Further, the first calculation module may calculate total power based on an operating rate of a CPU of the physical server to calculate the efficiency evaluation value.

Further, the first calculation module may sum operating power which is power generated in the physical server as the virtual machine operates and migration power which is power generated when the virtual machine is migrated, to calculate the total power.

Further, the first calculation module may sum the basic power which is the power generated when the CPU is in an idle state and the additional power generated when the virtual machine is operated and the CPU is operated, to calculate the operating power.

Further, the first calculation module may divide the power generated when the CPU is fully operated by a predetermined value to calculate an approximate basic power.

Further, the first calculation module may calculate the additional power based on a proportion of an operating frequency of the CPU with respect to a difference between a frequency when the CPU is fully operated and a frequency when the CPU is in an idle state.

Further, the first calculation module may calculate approximate migration power as a predetermined proportion to the power generated when the CPU is fully operated.

Further, the first calculation module may calculate the migration power based on a proportion of a frequency calculated as a predetermined proportion of the frequency at which the CPU is fully operated with respect to a difference between the frequency when the CPU is fully operated and the frequency when the CPU is in an idle state.

Further, the second calculation module may calculate the stability evaluation value based on a dirty memory rate and a network link rate.

A virtual machine arrangement evaluation method according to an embodiment of the present invention may be a virtual machine arrangement evaluation method for calculating an arrangement evaluation value, which indicates an evaluation for an arrangement of a virtual machine operated on a physical server, by utilizing a virtual machine arrangement evaluation apparatus, and may include a step of collecting, by a reception module, operation information, which is information generated when the virtual machine is operated, a step of calculating, by a first calculation module, an efficiency evaluation value, which is a value for the efficiency of the virtual machine arrangement, based on the operation information, a step of calculating, by a second calculation module, a stability evaluation value, which is a value for the stability of the virtual machine arrangement, based on the operation information, and a step of calculating, by an arrangement evaluation module, the arrangement evaluation value by utilizing the efficiency evaluation value and the stability evaluation value.

### Advantageous Effects

With the virtual machine optimal arrangement recommendation apparatus and the server operation system including the same according to the present invention, it is possible to maximize the stability of a server.

Further, it is possible to minimize manpower for server management.

Further, it is possible to minimize time required for server management.

However, the effects of the present invention are not limited to the effects described above, and effects that are not mentioned can be clearly understood by those skilled in the art from the present specification and the accompanying drawings.

### DESCRIPTION OF DRAWINGS

FIG. 1 is a relationship diagram of a server operation system according to an embodiment of the present invention.

FIG. 2 is a configuration diagram of a server operation system according to the embodiment of the present invention.

FIG. 3 is a flowchart of a virtual machine optimal arrangement recommendation method according to an embodiment of the present invention.

FIG. 4 is a diagram illustrating utilization weights of personal information and operation information in a virtual machine optimal arrangement recommendation method according to an embodiment of the present invention.

FIG. 5 illustrates an example of a video image for recommending a virtual machine arrangement in the virtual machine optimal arrangement recommendation method according to the embodiment of the present invention.

FIG. 6 illustrates an example in which a virtual machine arrangement according to a preference evaluation value in the virtual machine optimal arrangement recommendation method is displayed according to the embodiment of the present invention.

FIG. 7 is a flowchart of a server operating method according to the embodiment of the present invention.

### MODE FOR DISCLOSURE

Hereinafter, specific embodiments of the present invention will be described in detail with reference to the drawings. However, the spirit of the present invention is not limited to the presented embodiments, and those skilled in the art who understand the spirit of the present invention can easily propose other regressive inventions or other embodiments included within the scope of the spirit of the present invention by, for example, adding, changing, and deleting other components within the scope of the same spirit, which are included within the scope of the spirit of the present invention.

Further, components with the same function within the scope of the same spirit shown in the drawings of respective embodiments will be described using the same reference numerals.

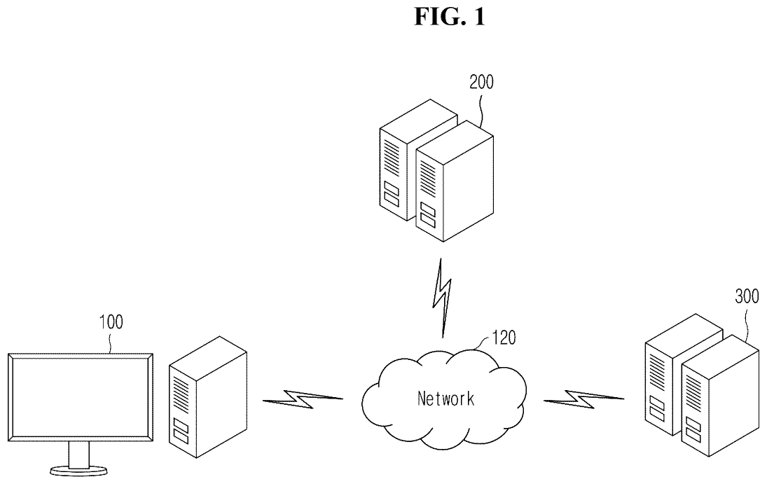

FIG. 1 is a relationship diagram of a server operation system according to the embodiment of the present invention.

Referring to FIG. 1, a server operation system 100 according to the embodiment of the present invention may be a system that, for example, operates, repairs, or transfers a virtual machine installed on a physical server.

As a specific example, the server operation system 100 can monitor whether a problem has occurred in a virtual machine, and solve the problem of the virtual machine when the problem occurs in the virtual machine. Further, the server operation system can also optimally place the virtual machine on the physical server in terms of resource utilization.

The server operation system 100 may be connected to the physical server 200 and/or the external server 300 via a wired/wireless network. The server operation system may collect and receive all pieces of information generated when the virtual machine is operated on the physical server, all pieces of information generated when the physical server is operated, and/or necessary information from the external server.

The network in the present invention may be a core network integrated with a wired public network, a wireless mobile communication network, or a mobile Internet, may be a global open computer network structure that provides various services existing in TCP/IP protocol and its upper layers, such as Hyper Text Transfer Protocol (HTTP), Hyper Text Transfer Protocol Secure (HTTPS), Telnet, File Transfer Protocol (FTP), Domain Name System (DNS), and Simple Mail Transfer Protocol (SMTP), and the present invention is not limited to these examples, but comprehensively include a data communication network that can transmit and receive data in various forms.

The physical server in the present invention may include other configurations for an environment of the server. The server may include any type of device.

For example, the server may be a digital device with computing power equipped with a processor and a memory, such as a laptop computer, a desktop computer, a web pad, or a mobile phone.

For example, the server may be a web server. However, the present invention is not limited thereto and a type of server may be changed in various ways at a level that is obvious to those skilled in the art.

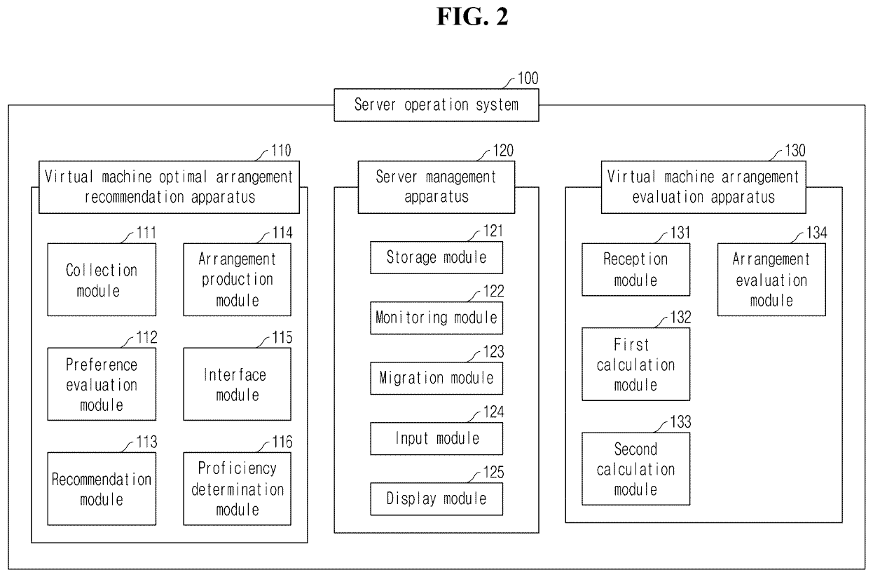

FIG. 2 is a configuration diagram of the server operation system according to the embodiment of the present invention.

Referring to FIG. 2, the server operation system 100 according to the embodiment of the present invention may include a virtual machine optimal arrangement recommendation apparatus 110, a server management apparatus 120, and a virtual machine arrangement evaluation apparatus 130.

The respective devices may be connected to each other via a wired/wireless network to transmit and receive necessary information.

The server management apparatus 120 may perform all processes necessary for operating the physical server.

The server management apparatus 120 may include a storage module 121 in which information required for managing and operating a physical server is stored, a monitoring module 122 that monitors in real time whether a virtual machine operated on the physical server operates abnormally, and a migration module 123 that moves the virtual machine between physical servers.

Further, the server management apparatus 120 may further include an input module 124 that receives a device control from a manager to generate a control signal, and transfers the control signal to the virtual machine optimal arrangement recommendation apparatus 110, the server management apparatus 120, and the virtual machine arrangement evaluation apparatus 130.

Further, the server management apparatus 120 may further include a display module 125 that displays information required for operation and management of the server management apparatus, such as values calculated by the virtual machine optimal arrangement recommendation apparatus 110, the server management apparatus 120, and the virtual machine arrangement evaluation apparatus 130, a status of the virtual machine, and a status of the physical server.

The storage module 121 may store all pieces of data necessary for the server management apparatus 120 to operate.

For example, the storage module may include internal memory and/or external memory.

For example, the internal memory may include at least one of a volatile memory (for example, DRAM, SRAM, or SDRAM) and a nonvolatile memory (for example, a one time programmable ROM (OTPROM), PROM, EPROM, EEPROM, mask ROM, flash ROM, flash memory, hard drive, or solid state drive (SSD)).

The external memory may include a flash drive, for example, a compact flash (CF), a secure digital (SD), a micro-SD, a mini-SD, an extreme digital (xD), a multi-media card (MMC), or a memory stick.

The monitoring module 122 may receive log data and metric data generated in the virtual machine, and monitor in real time whether the virtual machine is operating abnormally, such as experiencing an underload or overload.

The migration module 123 may move the virtual machine between physical servers when a problem occurs in the physical server or in response to a control signal from a manager.

The migration module 123 may determine, for example, whether migration is necessary or whether the physical server is suitable for migration before the migration module migrates a virtual machine.

The input module 124 allows the manager to input commands and command signals for management and operation of the server operation system 100.

For example, the input module may include a mouse, a keyboard, a touch panel, a (digital) pen sensor, a key, or an ultrasonic input device. The touch panel may use at least one of electrostatic, pressure-sensitive, infrared, or ultrasonic schemes, for example.

Further, the touch panel may further include a control circuit. The touch panel may further include a tactile layer to provide a tactile response to the user. The (digital) pen sensor may be, for example, a part of the touch panel or may include a separate recognition sheet.

Further, the key may include, for example, a physical button, an optical key, or a keypad.

Further, the ultrasonic input device may detect ultrasonic waves generated in an input tool through a microphone and check data corresponding to the detected ultrasonic waves.

The display module 125 may include all devices capable of displaying images, such as a display device, a screen device, and a beam projector.

For example, the display may include a panel, a hologram device, a projector, or a control circuit for controlling these.

The virtual machine optimal arrangement recommendation apparatus 110 according to the embodiment of the present invention may be a virtual machine optimal arrangement recommendation apparatus 110 for optimal arrangement of a virtual machine operated on a physical server, and include a collection module 111 configured to collect operation information, which is information generated when a manager operates the physical server; a preference evaluation module 112 configured to calculate a preference evaluation value related to management preference of the manager by using a predetermined preference calculation method based on the operation information; and a recommendation module 113 configured to select virtual machine arrangement on the physical server to be recommended to the manager by reflecting the preference evaluation value.

Further, the virtual machine optimal arrangement recommendation apparatus 110 may further include an arrangement production module 114 that produces an optimal arrangement, which is an arrangement of virtual machine on the physical server that satisfies predetermined arrangement conditions.

Further, the virtual machine optimal arrangement recommendation apparatus 110 may further an interface module 115 that produces an interface for displaying the recommendation information generated by the recommendation module 113 to the manager, and a proficiency determination module 116 that determines proficiency of the manager in operating the virtual machine management system based on the operation information.

The collection module 111 may collect operation information, which is information generated while the manager manages the physical server.

The operation information may include all log information and/or metric data of the physical server/virtual machine. Further, the operation information may also include all pieces of information on control data when the manager controls the physical server, and a current operating situation of the physical server and the virtual machine when the control data is generated.

For example, the operation information may include methods of the manager controlling the physical server and the virtual machine in order to resolve an abnormal situation in current states of the physical server and virtual machine.

The collection module 111 may collect the personal information of the manager when a predetermined collection amount of operation information is not collected.

For example, the predetermined collection amount may be 1 TB. However, the present invention is not limited thereto, and the predetermined collection amount may be changed in various ways at a level that is obvious to those skilled in the art.

The personal information may include information generated when the manager controls an electronic device externally regardless of the server operation system 100, and personal information of the manager.

To this end, the collection module 111 may be connected to an external server, a public institution server, an open server, or the like through the network to collect necessary information.

To this end, prior approval may be obtained from the manager.

For example, the personal information may include navigation route selection information of the manager.

Several routes may be recommended when a navigation route is searched for, and a navigation user may select one from the several routes according to his or her preference.

For this reason, using the manager's navigation application usage information may be helpful in understanding the preference tendency of the manager.

For example, the personal information can include car control information of the manager.

Recently, various car control information is being collected based on the expansion of IoT technology and the trend of electronic devices in cars. The collection module 111 may collect information on the manager controlling and controlling a car from a car manufacturing server and/or a telecommunications company server.

A car control method may be important information in ascertaining whether the manager is a person who values stability or efficiency.

The car control information may be fused with navigation information in the car and may be important information in ascertaining how the manager has controlled the car in traffic conditions and places.

For example, the personal information may include information on the manager's age, sex, school attended, major information, and hometown.

As people get older, the people tend to value the stability more than the efficiency.

Women value the stability more than the efficiency compared to men.

Since the academic culture of a university influences students, weights given to efficiency and stability may differ depending on a school of origin.

Since major influences a student, the weights given to efficiency and stability may differ depending the major.

Since whether a region of origin is a city, a rural region, or a fishing region, and the like influence residents, the weights given to the efficiency and the stability may differ.

For example, urban residents may emphasize the efficiency over the stability. Also, rural/fishing village residents may emphasize the stability over the efficiency.

The preference evaluation module 112 may calculate the preference evaluation value related to management preference of the manager by using the predetermined preference calculation method.

The preference evaluation module 112 may store a pattern classification model that classifies operation information into predetermined operation patterns.

The preference evaluation module 112 may generate the pattern classification model by performing deep learning based on classification information obtained by classifying operation information corresponding to past operation information.

In the deep learning, a back propagation algorithm which is an algorithm for updating a weight of a neural network using labeled data of an output layer may be used, but the present disclosure is not limited thereto.

Further, since the deep neural network and the back propagation algorithm are known in the related art, detailed description thereof may be omitted.

For example, the preference evaluation value may include values for efficiency and stability, the unit may be %, and a sum of the efficiency and the stability is 100.

However, the present invention is not limited thereto, and a form of the preference evaluation value may be changed in various ways at a level that is obvious to those skilled in the art.

The operation pattern may be classified by pattern in terms of the stability and the efficiency.

For example, a first operation pattern may be a pattern in which the stability is 0% and the efficiency is 100%, and a second operation pattern may be a pattern in which the stability is 2% and the efficiency is 98%. Thus, the operation patterns may be classified in terms of both the stability and the efficiency.

The predetermined preference calculation method may be a method of classifying the operation pattern of the virtual machine management system of the manager based on the operation information to calculate the preference evaluation value.

The preference evaluation value may be calculated in consideration of stability and efficiency.

The manager's management tendency can be effectively analyzed by the preference evaluation module 112.

The predetermined preference calculation method may be a method of calculating the preference evaluation value in consideration of both the personal information and the operation information.

The preference evaluation module 112 may calculate the preference evaluation value by utilizing the personal information together when the predetermined collection amount of operation information is not collected.

The preference evaluation module 112 may store a personal calculation model that calculates efficiency and stability using the personal information.

The preference evaluation module 112 may perform deep learning based on values obtained by classifying personal information corresponding to past personal information by efficiency and stability, to calculate the personal calculation model.

The deep learning algorithm may be a known technology, and detailed description thereof may be omitted.

The preference evaluation module 112 may weighted-average a first preference evaluation value calculated through the pattern classification model and a second preference evaluation value calculated by the personal calculation model, to calculate a final preference evaluation value.

The preference evaluation module 112 may calculate the preference evaluation value by changing the weights of the first preference evaluation value and the second preference evaluation value depending on the amount of collected operation information until a predetermined amount of operation information is collected.

For example, as the amount of collected operation information increases, the first preference evaluation value may be more heavily weighted than the second preference evaluation value, an average may be calculated, and the final preference evaluation value may be calculated.

When the amount of operation information is too small, the first preference evaluation value may not fully reflect the tendency and preference of the manager.

To compensate for this, the second preference evaluation value may be more heavily weighted by utilizing the personal information already accumulated as a considerable amount of data, to calculate the final preference evaluation value.

As the amount of operation information gradually increases, the weight of the first preference evaluation value may increase depending on the first proportion for the increased amount, and the weight of the second preference evaluation value calculated using the personal information may decrease.

The predetermined preference calculation method may be a method of calculating the preference evaluation value by changing the weight to which the personal information and the operation information are applied based on the operation proficiency.

In other words, the predetermined preference calculation method may be a method of changing the weight, with a rate at which the weight of the second preference evaluation value decreases as the weight of the first preference evaluation value increases as a different proportion from the first proportion, according to the operation proficiency, when the amount of collected operation information is greater than a predetermined reference value.

As a specific example, the preference evaluation module may set the rate at which the weight of the second preference evaluation value decreases as the weight of the first preference evaluation value increases to a second proportion higher than the first proportion to calculate the final preference evaluation value, when the amount of collected operation information is greater than a predetermined reference value (change reference value) and the operation proficiency of the manager is higher than the predetermined proficiency.

Further, when the amount of collected operation information is greater than a predetermined reference value and the operating proficiency of the manager is lower than the predetermined proficiency, the preference evaluation module may set the rate at which the weight of the second preference evaluation value decreases as the weight of the first preference evaluation value increases to a third rate lower than the first proportion, to calculate the final preference evaluation value.

This may be because when the proficiency of the manager is low, the consistency of the operation information is somewhat low, and thus the information reliability is somewhat low. On the other hand, when the proficiency of the manager is high, the consistency of the operation information is somewhat high, and thus the information reliability is somewhat high.

When the proficiency determination module 116 does not calculate the operating proficiency, the preference evaluation module may calculate the final preference evaluation value while maintaining the first proportion.

The proficiency determination module 116 may calculate the proficiency of the manager in operating the server operation system 100 based on the operation information.

To this end, the proficiency determination module 116 may store a proficiency determination model.

The proficiency determination module 116 may generate the proficiency determination model by performing deep learning on methods of operating the physical server and the virtual machine and evaluation scores thereof according to past statuses of the physical server and the virtual machine.

Since a specific algorithm for deep learning is known technology, detailed description thereof may be omitted.

The proficiency determination model may calculate the operating proficiency of the manager.

However, since the proficiency determination model requires only control information required for a determination of the operating proficiency and status information of the physical server and the virtual machine at the time of control in the operation information, a large amount of operation information does not necessarily indicate that sufficient information required for a determination of the operating proficiency is available.

The proficiency determination model may calculate the operating proficiency only when the amount of data required for a determination of the operating proficiency is equal to or larger than a certain criterion.

Here, the amount of data required for a determination of the operating proficiency may be smaller than the change reference value.

This may be intended to operate the above-described algorithm effectively.

The arrangement production module 114 may produce the virtual machine optimal arrangements.

To this end, the arrangement production module 114 may predict a future workload of the virtual machines and produce the virtual machine arrangements on the physical server in which a preset objective function is minimized based on a predicted workload.

Since a method by which the arrangement production module 114 produces the optimal arrangement of the virtual machine is a known technology, detailed description thereof may be omitted.

The arrangement production module 114 may request an arrangement evaluation module 134 to be described below to evaluate the calculated optimal arrangement.

The arrangement production module 114 may receive an arrangement evaluation value obtained by the arrangement evaluation module 134 evaluating the optimal arrangement using a predetermined evaluation method.

The arrangement production module 114 may transfer the arrangement evaluation value received from the arrangement evaluation module 134 and the optimal arrangement to the recommendation module 113.

The arrangement evaluation value may be in a form that takes stability and efficiency into account.

For example, the stability and the efficiency may be expressed as a percentage with a total value being 100, so that the arrangement evaluation value and the (final) preference evaluation value can be easily compared with each other.

The recommendation module 113 may classify the optimal arrangements in order of similarity of the arrangement evaluation value to the preference evaluation value according to a predetermined recommendation method, to select the virtual machine arrangement to be recommended.

The recommendation module 113 may compare the preference evaluation value with the arrangement evaluation value to recommend the virtual machine arrangement reflecting the preference of the manager among the optimal arrangements.

The recommendation module 113 may calculate recommendation information for recommending a recommendation ranking of the optimal arrangement in order of similarity of the arrangement evaluation value to the preference evaluation value among the optimal arrangements.

The predetermined recommendation method may be a method of comparing the arrangement evaluation value with the preference evaluation value to recommend virtual machine arrangement in order of similarity, and weighting the stability to recommend the virtual machine arrangement when the similarities are the same in the stability and the efficiency.

In other words, in the case of the virtual machine arrangement in which the preference evaluation value and the arrangement evaluation value are at the same distance, the stability is more emphasized, and the virtual machine arrangement with higher stability may be recommended with a higher ranking.

The interface module 115 may generate an interface for displaying both information on the optimal arrangement and the recommendation information.

The display module 125 may display the interface produced by the interface module 115, so that the manager can easily view the information required for managing and operating the server operation system 100.

The virtual machine arrangement evaluation apparatus 130 according to the embodiment of the present invention may be a virtual machine arrangement evaluation apparatus 130 for calculating an arrangement evaluation value, which indicates an evaluation for an arrangement of a virtual machine operated on a physical server, and may include a reception module 131 that collects operation information, which is information generated when the virtual machine is operated, a first calculation module 132 that calculates an efficiency evaluation value, which is a value for the efficiency of the virtual machine arrangement, based on the operation information, a second calculation module 133 that calculates a stability evaluation value, which is a value for the stability of the virtual machine arrangement, based on the operation information, and an arrangement evaluation module 134 that calculates the arrangement evaluation value by utilizing the efficiency evaluation value and the stability evaluation value.

The reception module 131 may collect the operation information, which is the information generated when the virtual machine is operated.

The operation information may include hardware operation information of the physical server by the virtual machine.

For example, the operation information may include CPU operation information, memory operation information, and network information, and the like, the present invention is not limited to the examples described above, and specific examples of the operation information may be changed in various ways at a level that is obvious to those skilled in the art.

The first calculation module may calculate the efficiency evaluation value.

The first calculation module 132 may calculate the total power based on the CPU operating rate of the physical server to calculate the efficiency evaluation value.

For example, the larger the total power, the larger the efficiency evaluation value may be, and the smaller the total power, the smaller the efficiency evaluation value may be.

For example, the CPU operating rate may be a CPU frequency and may be expressed in units of MHz.

The first calculation module 132 may sum operating power which is power generated in the physical server as the virtual machine operates and migration power which is power generated when the virtual machine is migrated, to calculate the total power.

$${E}_{total} = {E}_{host} + {E}_{migration} \qquad ( Equation 1 )$$

Here, Eₜₒₜₐₗ may be the total power (MW), Eₕₒₛₜ may be the operating power (MW), and Emigration may be migration power (MW).

That is, when the migration occurs, the total power may be calculated by summing the power generated during the migration and the power generated in the physical server due to the virtual machine arrangement after the migration.

The first calculation module 132 may sum the basic power which is the power generated when the CPU is in an idle state and the additional power generated when the virtual machine is operated and the CPU is operated, to calculate the operating power.

Further, the first calculation module 132 may divide the power generated when the CPU is fully operated by a predetermined value to calculate an approximate basic power.

Further, the first calculation module 132 may calculate the additional power based on a proportion of an operating frequency of the CPU with respect to a difference between a frequency when the CPU is fully operated and a frequency when the CPU is in an idle state.

$${E}_{host} = \frac{{TDP}_{model}}{2} + ( {\sum }_{i = 1}^{k} \frac{{CPU}_{{MHZ}_{i}}}{{CPU}_{{core}_{i}}} - {idle}_{freq} ) \times \frac{{TDP}_{model}}{2 * ( {base}_{freq} - {idle}_{freq} )} . \qquad ( Equation 1 ‐ 2 )$$

Here, TDP_{model} may be power generated in the physical server when the CPU operating rate is 100%, and

$$\frac{{TDP}_{model}}{2}$$

may mean the basic power.

Direct measurement of various pieces of experimental data and the power generated in the physical server has revealed that the basic power approximates to half of TDP_{model} as the number of physical servers in operation increases.

Here,

$$( {\sum }_{i = 1}^{k} \frac{{CPU}_{{MHZ}_{i}}}{{CPU}_{{core}_{i}}} - {idle}_{freq} ) \times \frac{{TDP}_{model}}{2 * ( {base}_{freq} - {idle}_{freq} )}$$

may be the additional power.

Further,

$${\sum }_{\text{?}}^{\text{?}} \frac{\text{?}}{\text{?}}$$

$$\text{?} \text{indicates text missing or illegible when filed}$$

may be an average of operating rates of all CPUs. The additional power may be calculated as the proportion of the operating frequency of the CPU with respect to the difference between the frequency when the CPU is fully operated and the frequency when the CPU is in an idle state.

Here, the operating frequency of the CPU may be a frequency of the CPU when the virtual machine operates for any purpose, like a case in which an application program operates on the physical server.

That is, base_{freq}-idle_{freq} may be the operating frequency of the CPU.

base_{freq} may be the frequency generated when the CPU is operated at 100%, and idle_{freq} may be a CPU frequency generated when the physical machine is only powered on without operating for any purpose.

Further, in Equation 1-2,

$$\frac{{TDP}_{model}}{2}$$

may be the additional power generated when the CPU is operated at 100%.

The first calculation module 132 may calculate approximate migration power as a predetermined proportion to the power generated when the CPU is fully operated.

Specifically, the first calculation module 132 may calculate the migration power based on a proportion of a frequency calculated as a predetermined proportion of the frequency when the CPU is fully operated with respect to the difference between the frequency when the CPU is fully operated and the frequency when the CPU is in an idle state.

$$\text{?} = \{ \text{?} \frac{\text{?}}{\text{?}} \} , \qquad ( Equation 1 ‐ 3 )$$

$$\text{?} \text{indicates text missing or illegible when filed}$$

where Wₓ may be a predetermined proportion.

The predetermined proportion may be changed depending on the performance of the physical machine, a size of the virtual machine being migrated, a type of the virtual machine, etc.

For example, the higher the performance of the physical machine, the lower the predetermined proportion.

For example, the larger the size of the virtual machine being migrated, the higher the predetermined proportion.

For example, the predetermined proportion may be 0.4 (40%).

However, the present invention is not limited thereto, and the predetermined proportion may be changed in various ways at a level that is obvious to those skilled in the art.

Further, in Equation 1-3,

$$\frac{{TDP}_{model}}{2}$$

may be the power additionally generated when the CPU is operated at 100%.

Eₜₒₜₐₗ may be calculated for each physical server.

The second calculation module 133 may calculate the stability evaluation value based on the dirty memory rate and the network link rate.

As a specific example, the second calculation module 133 may calculate a time required for migration by comparing a memory of the virtual machine, the dirty memory rate of the virtual machine, and the network link rate.

The second calculation module 133 may evaluate the time required for migration by comparing a size of the physical server with a size of the virtual machine, and classify a stability value into five categories: safety, stable, normal, warning, and danger.

Here, the safety level may have a higher stability evaluation value than the danger level.

The larger the memory of the virtual machine, the higher the dirty memory rate of the virtual machine, and the lower the network link rate, the smaller the stability evaluation value.

On the other hand, the smaller the memory of the virtual machine, the lower the dirty memory rate of the virtual machine, and the higher the network link rate, the larger the stability evaluation value.

The arrangement evaluation module 134 may calculate the arrangement evaluation value by utilizing the efficiency evaluation value and the stability evaluation value.

The arrangement evaluation module 134 calculates the efficiency evaluation value and the stability evaluation value for the physical machine at the time of evaluation, and compares the efficiency evaluation value and the stability evaluation value when the virtual machine arrangement is changed to the optimal arrangement received from the virtual machine optimal arrangement recommendation apparatus 110, to calculate the final arrangement evaluation value.

The arrangement evaluation module 134 calculates the efficiency evaluation value and the stability evaluation value for the physical machine at the time of evaluation, and compares the efficiency evaluation value and the stability evaluation value when the virtual machine arrangement is changed to a modified arrangement received from the server management apparatus 120, to calculate the final arrangement evaluation value.

When the efficiency evaluation value of the arrangement to be changed (the optimal arrangement or modified arrangement) is greater than the efficiency evaluation value of a current arrangement, the efficiency may increase.

On the other hand, when the efficiency evaluation value of the arrangement to be changed is smaller than the efficiency evaluation value of the current arrangement, the efficiency may decrease.

When the stability evaluation value of the arrangement to be changed is greater than the stability evaluation value of the current arrangement, the stability may increase.

On the other hand, when the stability evaluation value of the arrangement to be changed is smaller than the stability evaluation value of the current arrangement, the stability may decrease.

The arrangement evaluation value may be composed of values for efficiency and stability, the unit may be %, and a sum of efficiency and stability becomes 100.

To this end, the efficiency evaluation value and the arrangement evaluation value may be numerically processed.

For example, differences between the efficiency evaluation value of the current arrangement and the efficiency evaluation value of the arrangement to be changed may be classified for each difference between the stability evaluation value of the current arrangement and the stability evaluation value of the arrangement to be changed using a predetermined processing table, and the efficiency and stability may be designated in advance for each classification of the differences between the efficiency evaluation value of the current arrangement and the efficiency evaluation value of the arrangement to be changed.

However, the present invention is not limited thereto, and a method of processing the efficiency evaluation value and the arrangement evaluation value may be changed in various ways at a level that is obvious to those skilled in the art.

A base frequency is easy to measure, but an idle frequency may be difficult to measure. This may be because it is not practically possible to perform measurement by only supplying power without operating a server in an actual field.

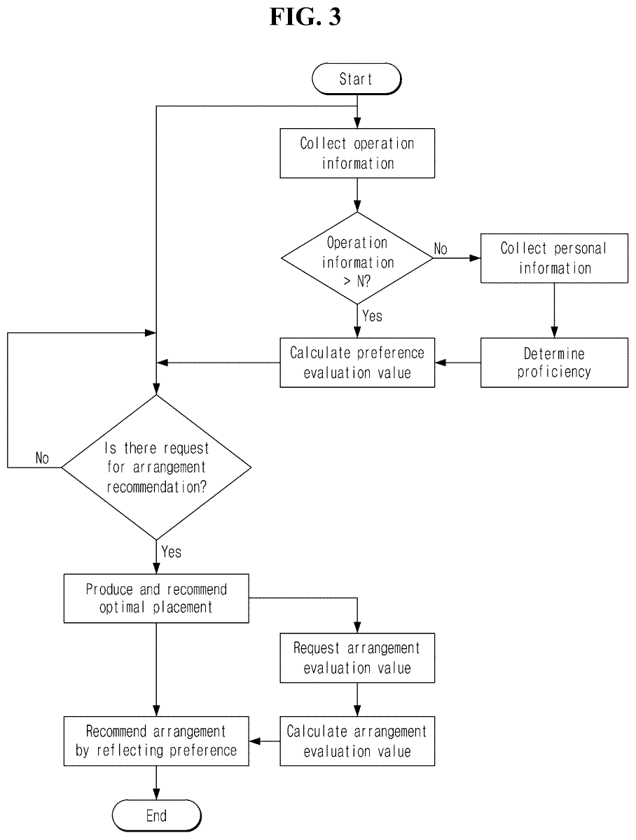

FIG. 3 is a flowchart of a method of recommending optimal arrangement of a virtual machine according to an embodiment of the present invention.

Hereinafter, detailed description may be omitted as long as the description overlaps the above-described content.

Referring to FIG. 3, a method of recommending optimal arrangement according to an embodiment of the present invention may be a method for managing a virtual machine implemented by a virtual machine management system to operate a virtual machine operated on a physical server, and may include collecting, by a collection module, operation information, which is information generated when a manager controls the virtual machine management system; calculating, by a preference evaluation module, a preference evaluation value related to preference of the manager by using a predetermined preference calculation method based on the operation information; and selecting, by a recommendation module, virtual machine arrangement on the physical server to the manager by reflecting the preference evaluation value.

The operation information may be collected by the collection module.

When a predetermined amount of operation information is not collected, the personal information of the manager may be collected, the proficiency may be determined, and the preference evaluation value may be calculated by utilizing the personal information and the proficiency.

When the predetermined amount of operation information is collected, the preference evaluation index can be calculated using only the operation information.

The preference evaluation value may be continuously updated until the manager requests to recommend the virtual machine arrangement through the input module.

When the manager requests to recommend the virtual machine arrangement, the arrangement production module may produce the optimal arrangement and request the virtual machine arrangement evaluation apparatus to evaluate the optimal arrangement.

The virtual machine arrangement evaluation apparatus may compare a current virtual machine arrangement with arrangement of the virtual machine when the virtual machine is placed in the optimal arrangement to calculate the arrangement evaluation value.

The recommendation module may compare the preference evaluation value with the arrangement evaluation value to calculate the optimal arrangements suitable for operating tendency and pattern of the manager in an order of similarity, and may recommend the virtual machine arrangement to the manager through the interface module and the display module.

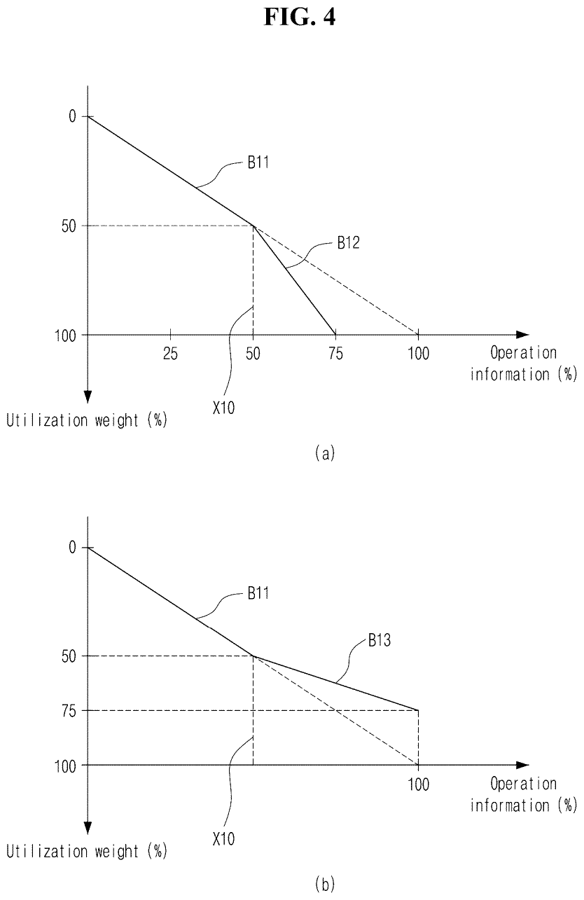

FIG. 4 is a diagram illustrating utilization weights of the personal information and operation information in the virtual machine optimal arrangement recommendation method according to the embodiment of the present invention.

Referring to FIG. 4, for example, when the operation information on an X-axis is utilized at 100% is when a predetermined amount of operation information is collected.

When no operation information is collected, only the personal information may be utilized at 100% to calculate the preference evaluation value.

As the amount of operation information gradually increases, the weight of the second preference evaluation value calculated by utilizing the personal information according to the first proportion for the increased amount may be reduced.

However, the present invention is not limited thereto, and the first proportion may be changed in various ways at a level that is obvious to those skilled in the art.

FIG. 4(a) is a diagram illustrating a case in which the operating proficiency is equal to or higher than a predetermined proficiency, and referring to FIG. 4(a), a predetermined reference value X10 of the amount of collected operation information may be half of the predetermined collection amount.

However, the present invention is not limited thereto, and the predetermined reference value may be changed in various ways at a level that is obvious to those skilled in the art.

When the amount of collected operation information is smaller than the predetermined reference value X10, the first preference evaluation value and the second preference evaluation value may be adjusted according to a first proportion B11 and the final preference evaluation value may be calculated, but when the amount of collected operation information is greater than the predetermined reference value, the first preference evaluation value and the second preference evaluation value may be adjusted according to a second proportion B12 and the final preference evaluation value may be calculated.

Accordingly, for example, even when only 75% of the predetermined collection amount of operation information is collected, the first preference evaluation value may be utilized at 100% and the final preference evaluation value may be calculated using only the first preference evaluation value.

FIG. 4(b) is a diagram illustrating a case in which the operating proficiency is lower than the predetermined proficiency. Referring to FIG. 4(b), the predetermined reference value X10 of the amount of collected operation information may be half of the predetermined collection amount.

However, the present invention is not limited thereto, and the predetermined reference value may be changed in various ways at a level that is obvious to those skilled in the art.

When the amount of collected operation information is smaller than the predetermined reference value X10, the first preference evaluation value and the second preference evaluation value may be adjusted according to the first proportion (B11) and the final preference evaluation value may be calculated, but when the amount of collected operation information is greater than the predetermined reference value, the first preference evaluation value and the second preference evaluation value may be adjusted according to a third ratio B13 and the final preference evaluation value may be calculated.

Accordingly, for example, even when the operation information is collected at 100% of the predetermined collection amount, the first preference evaluation value may be utilized at 75% and the second preference evaluation value may be utilized at 25% so that the final preference evaluation value can be calculated.

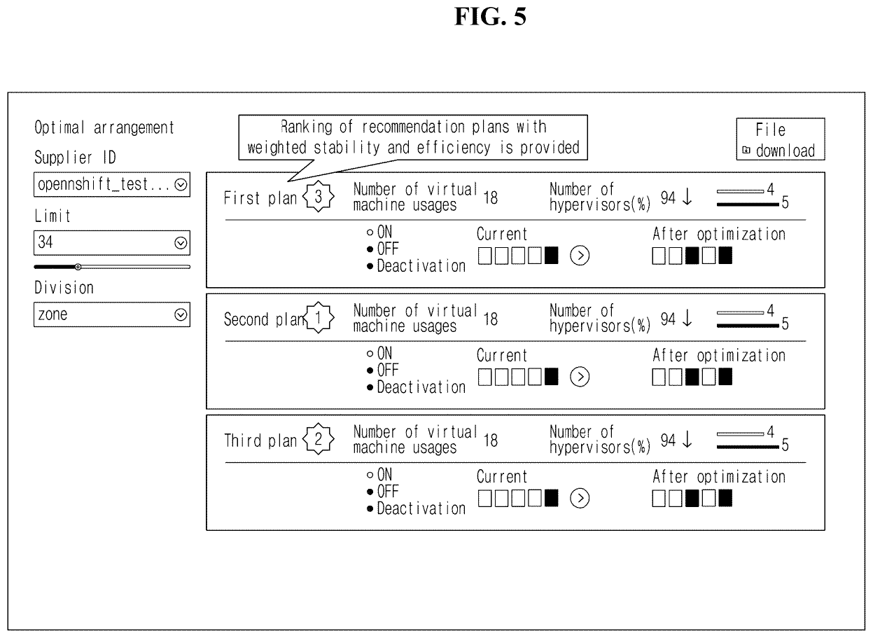

FIG. 5 illustrates an example of a video image for recommending the virtual machine arrangement in the virtual machine optimal arrangement recommendation method according to the embodiment of the present invention.

Referring to FIG. 5, the recommendation module may recommend the optimal arrangement and the recommended arrangement that reflects the preference of the manager, and the interface module may display the recommended information to the manager.

In the optimal arrangement, each objective function is minimized when there are a plurality of objective functions as first, second, and third plans, and three solutions may be produced.

Here, the preference evaluation value may have stability of 40% and efficiency of 60%, the arrangement evaluation value in the second plan may have stability of 41% and efficiency of 59%, the arrangement evaluation value in the third plan may have stability of 45% and efficiency of 55%, and the arrangement evaluation value in the first plan may have stability of 35% and efficiency of 65%.

The recommendation module may recommend the second plan with the arrangement evaluation value closest to the preference evaluation value as a first ranked plan, may recommend the third plan as a second ranked plan with more emphasis on the stability when the preference evaluation value and the arrangement evaluation value are at the same distance, and may recommend the first plan, which is the next in order, as a third ranked plan.

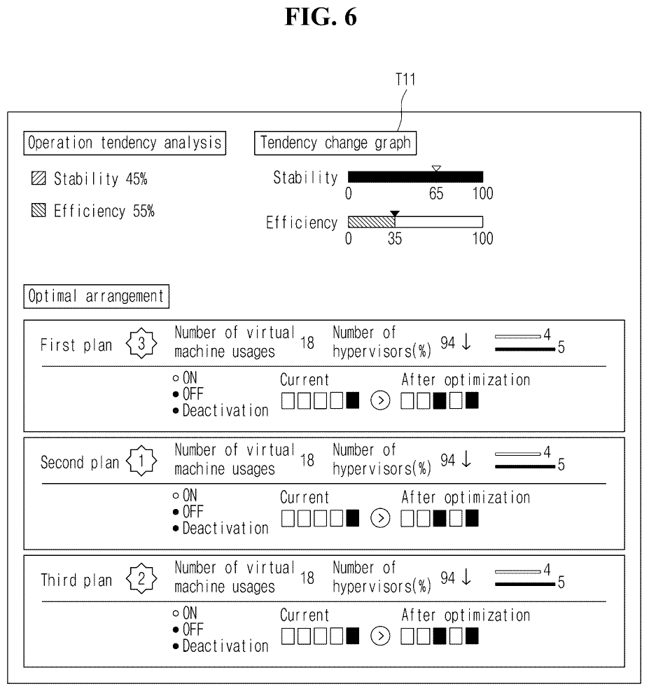

FIG. 6 illustrates an example in which the virtual machine arrangement according to the preference evaluation value in the virtual machine optimal arrangement recommendation method is displayed according to the embodiment of the present invention.

The interface module may provide an interface for re-recommending the optimal arrangement in order of similarity of the arrangement evaluation value to the preference evaluation value according to the predetermined recommendation method as the preference evaluation value of the manager is changed.

The interface module may change the preference evaluation value between a minimum value and a maximum value and may produce an interface for recommending the virtual machine arrangement on the physical server by reflecting the changed preference evaluation value.

FIG. 6 is a diagram illustrating a video screen in which the calculated preference evaluation value can be changed between a minimum value and a maximum value.

The manager may change the efficiency and stability of the preference evaluation value between 0 and 100 (T11), and the recommendation module may re-calculate recommendation information for re-recommending a recommendation ranking in the optimal arrangement in real time according to the predetermined recommendation method based on the changed preference evaluation value.

Therefore, when the manager has a question about an initial preference evaluation value, the manager may change this to receive a recommendation for a virtual machine optimal arrangement.

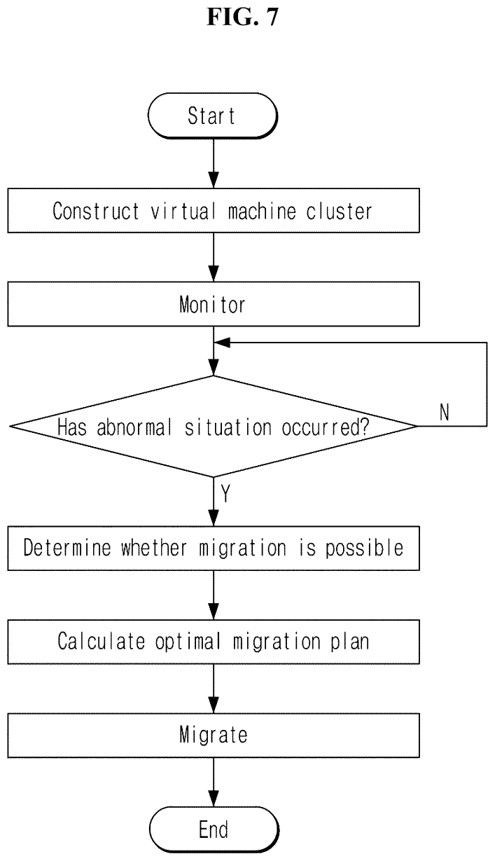

FIG. 7 is a flowchart of a server operation method according to an embodiment of the present invention.

Referring to FIG. 7, the monitoring module may monitor the virtual machine in real time to monitor whether the virtual machine and/or the physical machine operates abnormally.

The monitoring module may determine that the physical machine and/or the virtual machine operates abnormally, and the migration module may determine whether migration is necessary to solve the problem.

For example, the abnormal operation may result from an underload or overload of the virtual machine.

However, the present invention is not limited thereto, and the abnormal operation may be changed in various ways at a level that is obvious to those skilled in the art.

When the migration module determines that migration is necessary, the migration module may adopt a physical machine to which the virtual machine will be migrated and calculate an expected virtual machine arrangement in order to solve the problem.

The migration module may transfer the virtual machine arrangement to be changed to the virtual machine arrangement evaluation apparatus, to request the virtual machine arrangement evaluation apparatus to calculate the arrangement evaluation value in terms of stability and efficiency.

The arrangement evaluation value may be calculated by comparing a current virtual machine arrangement with a future arrangement of the virtual machine to be migrated.

The migration module determines whether to finally perform the migration based on the arrangement evaluation value, and perform the migration when the arrangement evaluation value satisfies a predetermined evaluation criterion.

For example, the predetermined evaluation criterion may be a condition under which the stability or efficiency is equal to or higher than a predetermined criterion (20%).

However, the present invention is not limited thereto, and the predetermined evaluation criterion may be changed in various ways at a level that is obvious to those skilled in the art.

A virtual machine arrangement evaluation method according to the embodiment of the present invention may be a virtual machine arrangement evaluation method for calculating an arrangement evaluation value, which indicates an evaluation for an arrangement of a virtual machine operated on a physical server, by utilizing a virtual machine arrangement evaluation apparatus, and may include a step of collecting, by a reception module, operation information, which is information generated when the virtual machine is operated, a step of calculating, by a first calculation module, an efficiency evaluation value, which is a value for the efficiency of the virtual machine arrangement, based on the operation information, a step of calculating, by a second calculation module, a stability evaluation value, which is a value for the stability of the virtual machine arrangement, based on the operation information, and a step of calculating, by an arrangement evaluation module, the arrangement evaluation value by utilizing the efficiency evaluation value and the stability evaluation value.

When there is a request from the virtual machine optimal arrangement recommendation apparatus and the server management apparatus, the virtual machine arrangement evaluation apparatus may evaluate the virtual machine arrangement in terms of stability and efficiency according to a situation and transmit an arrangement evaluation value.

To this end, information required for evaluation may be received from the server management apparatus and/or the virtual machine optimal arrangement recommendation apparatus.

In the accompanying drawings, components not related to or far from the technical spirit of the present invention are briefly expressed or omitted in order to express the technical spirit of the present invention more clearly.

Although the configuration and features of the present invention have been described based on the embodiments according to the present invention, the present invention is not limited thereto, it is obvious to those skilled in the art that various changes or modifications can be made within the spirit and scope of the present invention, and therefore, it is stated that such changes or modifications fall within the attached claims.

1. A virtual machine optimal arrangement recommendation apparatus for optimal arrangement of a virtual machine operated on a physical server, the virtual machine optimal arrangement recommendation apparatus comprising:
a collection module configured to collect operation information, which is information generated when a manager operates the physical server;
a preference evaluation module configured to calculate a preference evaluation value related to management preference of the manager by using a predetermined preference calculation method based on the operation information; and
a recommendation module configured to calculate recommendation information for recommending virtual machine arrangement on the physical server to the manager by reflecting the preference evaluation value.

2. The virtual machine optimal arrangement recommendation apparatus of claim 1, further comprising:
an arrangement calculation module configured to calculate an optimal arrangement which is a virtual machine arrangement on the physical server that satisfies a predetermined arrangement condition,
wherein the arrangement calculation module receives an arrangement evaluation value obtained by the arrangement evaluation module evaluating the optimal arrangement using a predetermined evaluation method, and
the recommendation module classifies the optimal arrangements in order of similarity of the arrangement evaluation value to the preference evaluation value according to a predetermined recommendation method, to select a virtual machine arrangement to be recommended.

3. The virtual machine optimal arrangement recommendation apparatus of claim 2, wherein the preference evaluation value and the arrangement evaluation value are calculated in consideration of stability and efficiency aspects.

4. The virtual machine optimal arrangement recommendation apparatus of claim 3, wherein the predetermined preference calculation method is a method of classifying an operation pattern of a virtual machine management system of the manager based on the operation information to calculate the preference evaluation value.

5. The virtual machine optimal arrangement recommendation apparatus of claim 2, wherein the predetermined recommendation method is a method of comparing the arrangement evaluation value with the preference evaluation value to recommend virtual machine arrangement in order of similarity, and weighting the stability to recommend the virtual machine arrangement when the similarity of the stability and the similarity of the efficiency are the same.

6. The virtual machine optimal arrangement recommendation apparatus of claim 1, further comprising:
an interface module configured to produce an interface for displaying the recommendation information generated by the recommendation module to the manager,
wherein the interface module produces the interface for displaying both optimal arrangement information and the recommendation information.

7. The virtual machine optimal arrangement recommendation apparatus of claim 6, wherein the interface module is able to change the preference evaluation value between a minimum value and a maximum value and produces an interface for recommending the virtual machine arrangement on the physical server by reflecting the changed preference evaluation value.

8. The virtual machine optimal arrangement recommendation apparatus of claim 2,
wherein the collection module collects personal information of the manager when a predetermined collection amount of operation information is not collected, and
the predetermined preference calculation method is a method of calculating the preference evaluation value in consideration of both the personal information and the operation information.

9. The virtual machine optimal arrangement recommendation apparatus of claim 8, further comprising:
a proficiency determination module configured to determine proficiency of a manager in operating the virtual machine management system based on the operation information,
wherein the predetermined preference calculation method is a method of calculating the preference evaluation value by changing a weight to which the personal information and the operation information are applied based on the operation proficiency.

10. A virtual machine management method implemented by a virtual machine management system to operate a virtual machine on a physical server, the virtual machine management method comprising:
collecting, by a collection module, operation information, which is information generated when a manager controls the virtual machine management system;
calculating, by a preference evaluation module, a preference evaluation value related to preference of the manager by using a predetermined preference calculation method based on the operation information; and
selecting, by a recommendation module, virtual machine arrangement on the physical server to the manager by reflecting the preference evaluation value.
